(19) United States
(12) Patent Application Publication
(10) Pub. No.: US 2020/0041740 A1
(43) Pub. Date: Feb. 6, 2020

(54) OPTICAL CABLE AND OPTICAL FIBER SYSTEM

(71) Applicant: EAST POINT COMMUNICATION TECHNOLOGY CO., LTD., Shenzhen (CN)

(72) Inventor: Haiqing Yan, Guangdong (CN)

(73) Assignee: EAST POINT COMMUNICATION TECHNOLOGY CO., LTD., Shenzhen (CN)

(21) Appl. No.: 16/601,784

(22) Filed: Oct. 15, 2019

Related U.S. Application Data
(63) Continuation-in-part of application No. PCT/CN2018/092677, filed on Jun. 25, 2018.

(30) Foreign Application Priority Data
Apr. 26, 2017 (CN) 201720446709.3

(51) Int. Cl. G02B 6/44

(52) U.S. Cl. CPC G02B 6/4432

(57) ABSTRACT

Provided is an optical fiber cable and optical fiber system. The optical fiber cable includes: at least two optical fibers (1) configured to transmit optical signals; a central tube (4) wrapped around an outer side of the optical fibers (1) and configured to protect the optical fibers (1); an aramid fiber layer (2) including a plurality of uniformly distributed aramid fibers, which are wrapped around an outer side of the central tube (4), and configured to improve tensile resistance of the optical fiber cable and protect the at least two optical fibers (1) and the central tube (4) on an inner side of the aramid fiber layer (2); and a protective jacket (3) wrapped around an outer side of the aramid fiber layer (2) and configured to protect the optical fibers (1), the central tube (4) and the aramid fiber layer (2) on an inner side of the protective jacket (3).

### CROSS-REFERENCE TO RELATED APPLICATIONS

This application is a continuation-in-part of PCT International Application No. PCT/CN/2018/092677 filed on Jun. 25, 2018, which claimed the priority to Chinese patent application No. 201720446709.3 filed on Apr. 26, 2017, the disclosures of both of which are incorporated herein by reference in their entireties.

### TECHNICAL FIELD

The present disclosure relates to the field of optical fiber cables for communications, for example, to an optical fiber cable and an optical fiber system.

### BACKGROUND

An optical fiber, a kind of fiber made of glass or plastic, may be used as a light transmission tool and is mainly used to transmit optical signals. The optical fiber is relatively fragile. The optical fiber in the related art must be wrapped by several layers of protection structure before being used, and the formed cable is called an optical fiber cable. The protective layer and the insulation layer outside the optical fiber may effectively prevent the optical fiber from being damaged by external environments such as water, fire or electric shocks.

### SUMMARY

The following is a summary of the subject matter described in detail herein. The summary is not intended to limit the scope of the claims.

The present disclosure provides an optical fiber cable and an optical fiber system. The optical fiber cable has strong tensile resistance and high reliability.

An optical cable includes at least two optical fibers, a central tube, an aramid fiber layer and a protective jacket.

The optical fibers are configured to transmit optical signals.

The central tube is wrapped on an outer side of the optical fibers and configured to wrap and protect the optical fibers.

The aramid fiber layer includes a plurality of uniformly distributed aramid fibers, the aramid fibers are wrapped on an outer side of the central tube, and configured to improve tensile resistance of the optical fiber cable and protect the optical fibers and the central tube on an inner side of the aramid fiber layer.

The protective jacket is wrapped on an outer side of the aramid fiber layer and configured to protect the optical fibers, the central tube and the fiber filament layer on an inner side of the protective jacket.

In an embodiment, the central tube is movably sleeved on the outer side of the optical fibers to enable the optical fibers to move freely relative to the central tube.

The central beam tube is movably sleeved on the outer side of the optical fibers, so that the optical fibers are protected and flexibility of the optical fibers in the optical fiber cable of the present disclosure is improved. In this way, when mechanical properties tests are performed on a Multi-fiber Push On (MPO) connector, resistance of the aramid fiber layer on the optical fibers is avoided, and the optical fibers may extend and contract more flexibly relative to the optical cable in the present disclosure, thereby improving reliability and stability of optical fiber communication of the optical fiber cable and the MPO component.

In an embodiment, the central tube is a tubular structure. The tubular structure occupies a smaller volume and ensures the flexibility of the optical fibers on the inner side of the central tube relative to the central tube, thereby improving the reliability and stability of the optical fiber communication of the present disclosure.

In an embodiment, the central tube has an inner diameter of 1.2 millimeters and an outer diameter of 1.7 millimeters. This central tube with an ultra-small inner diameter reduces a cross sectional area of the central tube and lowers the costs of raw materials on the premise of ensuring an effect of protecting the optical fibers on the inner side of the central tube.

In an embodiment, 12 optical fibers are provided. The provision of 12 optical fibers improves an optical communication capacity of the present disclosure and meets universal standards of an optical fiber system.

In an embodiment, each of the optical fibers has a diameter of 250 microns. Such a configuration makes full use of space in the central tube on the premise of ensuring flexibility of the optical fibers relative to the central tube.

In an embodiment, the protective jacket has an outer diameter of 3 millimeters. Such a configuration provides enough space for accommodating the aramid fiber layer, the central tube and the optical fibers on the inner side of the protective jacket on the premise of providing enough protection strength with a small cross sectional area.

In an embodiment, the optical fiber cable is configured to be directly connected to the MPO connector. Such a configuration increases practicality and increases installation efficiency of the optical fiber cable in the present disclosure.

The present disclosure further provides an optical fiber system including the optical fiber cable described above. Such a configuration avoids performance differences among a plurality of optical fiber channels and improves stability and reliability of the optical fiber system.

In the optical fiber provided by the present disclosure, the aramid fiber layer is wholly disposed on the outer side of the optical fibers is separated from the optical fibers through the central tube, so that on the premise of ensuring a basic function of the optical fibers, the aramid fiber layer under stress has no adverse impact on the optical fibers on the inner side of the aramid fiber layer, avoiding performance differences of the optical fiber communications.

Other aspects can be understood after the drawings and the detailed description are read and understood.

### BRIEF DESCRIPTION OF DRAWINGS

FIG. 1 is a structural schematic diagram of an optical fiber cable according to an embodiment.

FIG. 2 is a cross sectional view of an optical fiber cable according to an embodiment.

FIG. 3 is a schematic diagram of a mechanical properties test in the related art.

In the drawings:

1: Optical fibers; 2: Aramid fiber layer; 3: Protective jacket; 4: Central tube.

### DETAILED DESCRIPTION

A related optical cable basically includes a cable jacket, aramid fibers, a buffer layer and one or more optical fibers. The specific structure of the optical cable may be changed according to different application occasions. Even if the same optical cable is selected in the same application occasion, a method for connecting the optical cable may be changed according to specific requirements. In the related art, the optical cable is mainly connected in three manners: permanent connection (fusion splice), emergency connection (field mountable connection), and pluggable connection (connection between a plug and a socket).

A Multi-fiber Push On (MPO) connector is a kind of optical fiber connector, and is mainly used for connecting a multi-core optical fiber cable. To enhance tensile resistance of the multi-core optical fiber cable, the aramid fibers and the optical fibers are usually mixedly twined and disposed in a same outer protective jacket. At this time, when the whole optical fiber cable bears tensile stress, the stress is borne by the aramid fibers with better tensile resistance, so as to protect the optical fibers. However, when the aramid fibers are mixed with multiple optical fibers, the optical fibers also share the tensile stress, affecting performance of the optical fibers.

When a mechanical reliability test is performed on the MPO component, because the aramid fibers and the optical fibers are mixed and are subject to the tensile stress, the optical fibers may adversely affect reliability of the MPO component.

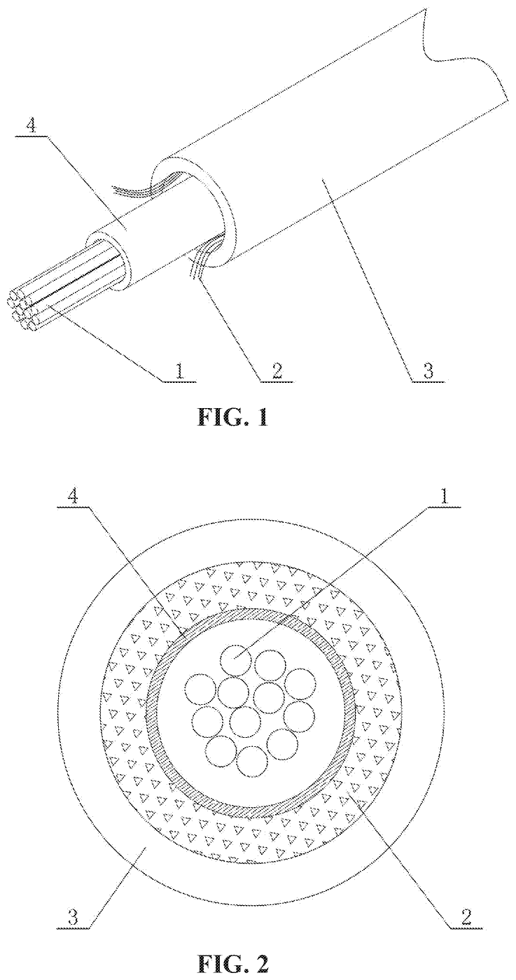

As shown in FIG. 1 and FIG. 2, the present disclosure provides an optical fiber cable. The optical fiber cable includes optical fibers 1, an aramid fiber layer 2 and a protective jacket 3. At least two optical fibers 1 are provided for transmitting optical signals. The aramid fiber layer 2 includes uniformly distributed aramid fibers. The aramid fibers are wrapped on an outer side of the optical fibers 1, and are configured to improve tensile resistance of the optical fiber cable and protect the optical fibers 1 on an inner side of the aramid fiber layer 2. The protective jacket 3 is wrapped on an outer side of the aramid fiber layer 2, and is configured to protect the optical fibers 1 and the aramid fiber layer 2 on an inner side of the protective jacket 3. The aramid fiber layer 2 is wholly disposed on the outer side of the optical fibers 1 and separated from the optical fibers 1. On the premise of ensuring a basic function of the optical fibers 1, the aramid fiber layer 2 under stress has no adverse impact on the optical fibers 1 on the inner side of the aramid fiber layer 2, thereby avoiding communication performance differences among multiple optical fibers 1.

In an embodiment, the optical fiber cable further includes a central tube 4, so that the optical fiber cable is a central tube-included optical cable. The central tube 4 is disposed between the optical fibers 1 and the aramid fiber layer 2, and is configured to wrap and protect the optical fibers 1, so that the outermost protective jacket 3 wholly wraps and protects the aramid fiber layer 2, the central tube 4 and the optical fibers 1 on the inner side of the protective jacket 3. The central tube 4 protects the optical fibers 1, thereby improving reliability of the optical fiber cable.

In an embodiment, the central tube 4 is movably sleeved on the outer side of the optical fibers 1, so that the optical fibers 1 may freely move relative to the central tube 4. In a specific configuration, the inner diameter of the central tube 4 is slightly larger than the diameter of a cross sectional area occupied by the optical fibers 1, i.e., a certain gap exists between an inner wall of the central tube 4 and the outer side of the optical fibers 1, so that the optical fibers 1 may move freely relative to the central tube 4. The central tube 4 is movably sleeved on the outer side of the optical fibers 1, so that the central tube 4 protects the optical fibers 1 and improves flexibility of the optical fibers 1 in the optical fiber cable. In this way, when mechanical properties tests are performed on an MPO component, resistance of the central tube 4 on the optical fibers 1 is avoided, and the optical fibers 1 may extend and contract more flexibly with respect to the optical fiber cable, thereby improving reliability and stability of the optical fiber communication of the optical fiber cable and the MPO component.

In an embodiment, the central tube 4 is a tubular structure. The tubular structure occupies a smaller volume and ensures the flexibility of the optical fibers 1 on the inner side of the central tube 4 relative to the central tube 4, thereby improving reliability of the optical fiber cable and stability of the communication of the optical fibers 1.

In an embodiment, the central tube 4 has an inner diameter of 1.2 millimeters and an outer diameter of 1.7 millimeters. The central tube 4 with this inner diameter reduces a cross sectional area of the central tube 4 and lowers the costs of raw materials on the premise of ensuring an effect of protecting the optical fibers 1 on the inner side of the central tube 4.

In an embodiment, 12 optical fibers 1 are provided. The provision of 12 optical fibers improves an optical communication capacity and meets universal standards of an optical fiber system.

In an embodiment, each of the optical fibers 1 has a diameter of 250 microns. Such a configuration makes full use of space in the central tube 4 on the premise of ensuring flexibility of optical fibers 1 relative to the central tube 4.

In an embodiment, the protective jacket 3 has an outer diameter of 3 millimeters. Such a configuration provides enough space for accommodating the aramid fiber layer 2, the central tube 4 and the optical fibers 1 on the inner side of the protective jacket on the premise of providing enough protection strength with a small cross sectional area.

In an embodiment, the optical fiber cable is configured to be directly connected to the MPO connector. Such a configuration increases practicality and improves installation efficiency of the optical fiber cable.

In an embodiment, an optical fiber system including the optical cable described above is further provided. Such a configuration avoids performance differences among a plurality of optical fiber channels and improves stability and reliability of the optical fiber system.

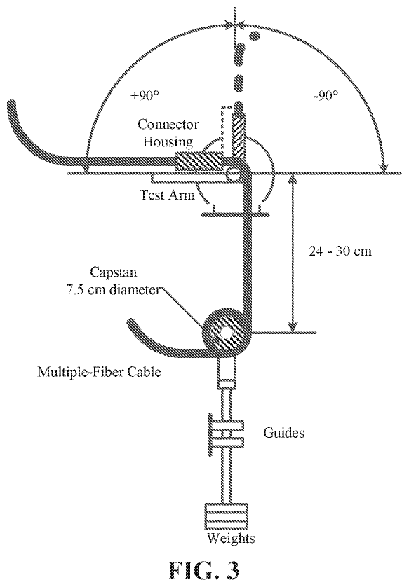

FIG. 3 is a schematic diagram of a mechanical properties test. The mechanical properties test, also called tension test, is used for testing the mechanical properties of an optical fiber cable, so as to obtain data on the reliability of the connection between the optical fiber cable and a MPO connector.

In the test, the mechanical properties of the optical fiber cable may be represented by the power loss of the signal transmitted in the optical fiber cable. Such power loss includes insertion loss and return loss, both of which result from the insertion of the MPO connector into the optical fiber cable. An optical fiber cable corresponding to larger insertion loss and/or return loss has worse mechanical properties, while an optical fiber cable corresponding to less insertion loss and/or return loss has better mechanical properties.

Table 1 shows exemplary test results for a traditional optical fiber cable in the related art.

TABLE 1
Traditional Optical Fiber Cable

| | Test Wavelength | | | | | | | | | | | |
|---|---|---|---|---|---|---|---|---|---|---|---|---|
| | | | | | During Test Under Load | | | | | | | |
| | Before Test | | | | 33N@0 degree | | | | Variation | | | |
| | 1310 nm | | 1550 nm | | 1310 nm | | 1550 nm | | 1310 nm | | 1550 nm | |
| | IL | RL | IL | RL | IL | RL | IL | RL | IL | RL | IL | RL |
| Fiber | (dB) | (dB) | (dB) | (dB) | (dB) | (dB) | (dB) | (dB) | (dB) | (dB) | (dB) | (dB) |
| 1 | 0.05 | −74.1 | 0.08 | −77 | 0.18 | −64.5 | 0.47 | −53.0 | 0.13 | 9.6 | 0.39 | 24.0 |
| 2 | 0.23 | −74.8 | 0.28 | −74.4 | 0.45 | −62.5 | 0.73 | −53.1 | 0.22 | 12.3 | 0.45 | 21.3 |
| 3 | 0.08 | −70.8 | 0.11 | −72.4 | 0.46 | −59.0 | 0.63 | −51.9 | 0.38 | 11.8 | 0.52 | 20.5 |
| 4 | 0.09 | −73.1 | 0.15 | −73.3 | 0.67 | −58.6 | 0.75 | −51.2 | 0.58 | 14.5 | 0.60 | 22.1 |
| 5 | 0.12 | −73.8 | 0.16 | −75.1 | 0.60 | −57.4 | 0.71 | −51.3 | 0.48 | 16.4 | 0.55 | 23.8 |
| 6 | 0.07 | −73.8 | 0.1 | −76.9 | 0.68 | −58.3 | 0.65 | −51.5 | 0.61 | 15.5 | 0.55 | 25.4 |
| 7 | 0.05 | −71.1 | 0.08 | −73.9 | 0.60 | −57.6 | 0.56 | −51.3 | 0.55 | 13.5 | 0.48 | 22.6 |
| 8 | 0.09 | −73.7 | 0.2 | −74.1 | 0.61 | −57.6 | 0.61 | −52.3 | 0.52 | 16.1 | 0.41 | 21.8 |
| 9 | 0.02 | −73.3 | 0.04 | −74.9 | 0.61 | −59.2 | 0.55 | −51.9 | 0.59 | 14.1 | 0.51 | 23.0 |
| 10 | 0.13 | −73.5 | 0.17 | −75 | 0.73 | −57.3 | 0.71 | −51.2 | 0.60 | 16.2 | 0.54 | 23.8 |
| 11 | 0.29 | −73.4 | 0.23 | −74.4 | 0.80 | −57.3 | 0.71 | −51.9 | 0.51 | 16.1 | 0.48 | 22.5 |
| 12 | 0.15 | −75.9 | 0.16 | −73.6 | 0.65 | −56.7 | 0.68 | −51.0 | 0.50 | 19.2 | 0.52 | 22.6 |

Table 2 shows exemplary test results for an optical fiber cable according to the present disclosure.

TABLE 2
Optical Fiber Cable of Present Disclosure

| | Test Wavelength | | | | | | | | | | | |
|---|---|---|---|---|---|---|---|---|---|---|---|---|
| | | | | | During Test Under Load | | | | | | | |
| | Before Test | | | | 33N@0 degree | | | | Variation | | | |
| | 1310 nm | | 1550 nm | | 1310 nm | | 1550 nm | | 1310 nm | | 1550 nm | |
| | IL | RL | IL | RL | IL | RL | IL | RL | IL | RL | IL | RL |
| Fiber | (dB) | (dB) | (dB) | (dB) | (dB) | (dB) | (dB) | (dB) | (dB) | (dB) | (dB) | (dB) |
| 1 | 0.11 | −73.7 | 0.09 | −75.5 | 0.09 | −74.0 | 0.07 | −74.0 | −0.02 | −0.3 | −0.02 | 1.5 |
| 2 | 0.03 | −73.1 | 0.04 | −76.4 | 0.02 | −73.3 | 0.03 | −77.4 | −0.01 | −0.2 | −0.01 | −1.0 |
| 3 | 0.11 | −73 | 0.07 | −74.6 | 0.10 | −73.3 | 0.06 | −74.5 | −0.01 | −0.3 | −0.01 | 0.1 |
| 4 | 0.08 | −73.1 | 0.1 | −74.8 | 0.07 | −73.2 | 0.10 | −74.6 | −0.01 | −0.1 | 0.00 | 0.2 |
| 5 | 0.06 | −73.6 | 0.16 | −73.8 | 0.06 | −73.8 | 0.15 | −76.4 | 0.00 | −0.2 | −0.01 | −2.6 |
| 6 | 0.02 | −74.7 | 0.03 | −75.7 | 0.03 | −73.5 | 0.03 | −76.3 | 0.01 | 1.2 | 0.00 | −0.6 |
| 7 | 0.05 | −73.4 | 0.06 | −75.6 | 0.06 | −72.2 | 0.08 | −76.8 | 0.01 | 1.2 | 0.02 | −1.2 |
| 8 | 0.31 | −74.1 | 0.35 | −77.8 | 0.32 | −73.6 | 0.35 | −73.7 | 0.01 | 0.5 | 0.00 | 4.1 |
| 9 | 0.17 | −74.1 | 0.2 | −77 | 0.19 | −72.8 | 0.21 | −73.7 | 0.02 | 1.3 | 0.01 | 3.3 |
| 10 | 0.2 | −74.4 | 0.23 | −76.6 | 0.22 | −74.5 | 0.25 | −75.3 | 0.02 | −0.1 | 0.02 | 1.3 |
| 11 | 0.03 | −75.4 | 0.06 | −76.5 | 0.02 | −74.3 | 0.07 | −76.2 | −0.01 | 1.1 | 0.01 | 0.3 |
| 12 | 0.02 | −74.8 | 0.02 | −75.6 | 0.03 | −74.8 | 0.02 | −72.7 | 0.01 | 0.0 | 0.00 | 2.9 |

In Table 1 and Table 2, IL refers to insertion loss and is expressed in units of dB, and RL refers to return loss and is expressed in units of dB.

The comparison between the data in Table 1 and the data in Table 2 shows that, under the same conditions and with the same test wavelength, the insertion loss and the return loss for the traditional optical fiber cable is significantly larger than those for the optical fiber cable according to the present disclosure.

What is claimed is:

1. An optical fiber cable, comprising:
at least two optical fibers, which are configured to transmit optical signals;
a central tube, which is wrapped around an outer side of the optical fibers and configured to protect the optical fibers;
an aramid fiber layer, which comprises a plurality of uniformly distributed aramid fibers, wherein the aramid fibers are wrapped around an outer side of the central tube, the aramid fibers are configured to improve tensile resistance of the optical fiber cable and protect the optical fibers and the central tube on an inner side of the aramid fiber layer; and
a protective jacket, which is wrapped around an outer side of the aramid fiber layer and configured to protect the optical fibers, the central tube and the aramid fiber layer on an inner side of the protective jacket.

2. The optical fiber cable of claim 1, wherein the central tube is movably sleeved on the outer side of the optical fibers to enable the optical fibers to move freely relative to the central tube.

3. The optical fiber cable of claim 2, wherein the central tube is a tubular structure.

4. The optical fiber cable of claim 3, wherein the central tube has an inner diameter of 1.2 millimeters and an outer diameter of 1.7 millimeters.

5. The optical fiber cable of claim 1, wherein the optical fibers comprise 12 optical fibers.

6. The optical fiber cable of claim 5, wherein each of the optical fibers has a diameter of 250 microns.

7. The optical fiber cable of claim 6, wherein the protective jacket has an outer diameter of 3 millimeters.

8. The optical fiber cable of claim 7, wherein the optical fiber cable is arranged to be directly connected to a Multi-fiber Push On (MPO) connector.

9. An optical fiber system, comprising an optical fiber cable,
wherein the optical fiber cable comprises:
at least two optical fibers, which are configured to transmit optical signals;
a central tube, which is wrapped around an outer side of the optical fibers and configured to protect the optical fibers;
an aramid fiber layer, which comprises a plurality of uniformly distributed aramid fibers, wherein the aramid fibers are wrapped around an outer side of the central tube, the aramid fibers are configured to improve tensile resistance of the optical fiber cable and protect the optical fibers and the central tube on an inner side of the aramid fiber layer; and
a protective jacket, which is wrapped around an outer side of the aramid fiber layer and configured to protect the optical fibers, the central tube and the aramid fiber layer on an inner side of the protective jacket.
